(19) United States
(12) Patent Application Publication
(10) Pub. No.: US 2010/0199538 A1
(43) Pub. Date: Aug. 12, 2010

(54) LOCKING DEVICE AND LABEL HOLDER MOUNT FOR MERCHANDISE DISPLAY HOOKS

(75) Inventors: John F. Roberts, Charlotte, NC (US); Michael R. Johnston, Waxhaw, NC (US); Kai-Sheng Cheng, Charlotte, NC (US); Gregory C. Schultz, Huntersville, NC (US)

Correspondence Address: Christopher C. Dremann, P.C., 15015 Lancaster Highway, Charlotte, NC, 28277, US

(73) Assignee: INVUE SECURITY PRODUCTS INC., Charlotte, NC (US)

(21) Appl. No.: 12/701,876

(22) Filed: Feb. 8, 2010

Related U.S. Application Data
(60) Provisional application No. 61/150,632, filed on Feb. 6, 2009.

(51) Int. Cl. G09F 3/20; E05B 73/00; G09F 3/18

(52) U.S. Cl. 40/642.01; 211/7

(57) ABSTRACT

A locking device for a merchandise display hook includes a housing disposed adjacent a free end of the merchandise hook and defining an interior cavity adapted for receiving an end portion of the display hook. A shuttle biased by a biasing spring secures the end portion of the display hook in a locked configuration within the interior cavity. A label holder mount is integrally formed with the housing and disposed adjacent the free end of the merchandise display hook. The label holder mount is adapted for mounting a plurality of different types of label holders on the display hook. In one embodiment, a bayonet at least partially disposed within the interior cavity is movable between an unlocked configuration wherein the end portion of the display hook is removable from the interior cavity and the locked configuration wherein the end portion of the display hook is secured within the interior cavity and the locking device is locked onto the display hook with the bayonet positioned between the end portion and the housing.

### BACKGROUND OF THE INVENTION

This invention relates generally to merchandise display hooks for supporting and displaying items of merchandise. More particularly, the invention relates to a locking device for locking items of merchandise on a merchandise display hook and a label holder mount for mounting a label holder on the display hook. In preferred embodiments, the invention is an integral locking device and interchangeable label holder mount for use with a merchandise display hook.

It is common practice for retailers to display relatively small, relatively expensive items of merchandise on a display hook mounted on a vertical wall display support, such as pegboard, slatwall or wire grid. The display hook allows a potential purchaser to view an item of merchandise prior to purchase. At the same time, the display hook permits the retailer to stock multiple items of merchandise on each of several display hooks in a limited amount of space, thereby increasing the number of items displayed on the display support, while reducing the need to repeatedly stock the items. The large number of relatively small and relatively expensive items, however, makes the merchandise an attractive target for shoplifters. A shoplifter may attempt to discretely remove only one item of merchandise at a time from the display hook. Often, however, the shoplifter attempts to remove all of the items of merchandise from the display hook at the same time, commonly referred to in the security art as “sweeping.” As a result, many merchandise display hooks include an anti-sweeping feature. Most anti-sweeping features, however, merely increase the amount of time required to remove an item of merchandise from the display hook, and in some instances, prevent the removal of more than one item at a time. Although anti-sweeping features are effective to reduce theft, they do not entirely prevent an unauthorized person from removing an item of merchandise from the display hook. Accordingly, in some instances it is desirable that the display hook include a locking device for locking the items of merchandise on the display hook.

It is also desirable in many instances for a merchandise display hook to include a mount for mounting a label holder to the display hook. Both the locking device and the label holder mount are typically located at the free end of the display hook opposite the display support. The locking device is located at the free end of the display hook so as to permit a greater number of the items of merchandise to be stocked on the display hook. The label holder mount is preferably located at the free end of the display hook so that information about the items of merchandise, for example the name and price of the items, is clearly visible to a potential purchaser. However, if both the locking device and the label holder mount are located at the free end of the display hook the locking device can obscure visibility of the label on the label holder. Alternatively, the label holder mount can limit access to the locking device thereby making it difficult and time consuming for an authorized person (e.g. sales personnel) to unlock the locking device and remove the merchandise. As a result, a potential purchaser may be inconvenienced and possibly frustrated enough to not purchase the item. In order to ensure visibility of the label while also providing access to the locking device, the label holder mount may be combined with the locking device into an integral structure. Retailers, however, utilize different types of label holders for different products. Furthermore, certain types of label holders are more commonly utilized in certain areas of the world. Thus, an integral locking device and label holder mount results in an undesirable number of styles of merchandise display hooks for different types of label holders, each of which must be separately manufactured and inventoried.

Accordingly, there exists an unresolved need for a locking device for locking items of merchandise on a merchandise display hook and a label holder mount for attaching a label holder to the display hook. There exists a further need for a locking device and label holder mount for a merchandise display hook that does not obscure visibility of the label or limit access to the locking device. There exists a further need for a locking device and label holder mount for a merchandise display hook that permits retailers to utilize different types of label holders. There exists a still further, and more specific, need for an integral locking device and interchangeable label holder mount for use with a merchandise display hook.

### BRIEF SUMMARY OF THE INVENTION

The aforementioned needs, objectives and advantages, as well as others readily apparent to those of ordinary skill in the art, are provided by a locking device and a label holder mount according to the present invention. The present invention provides a locking device for locking items of merchandise on a merchandise display hook and a label holder mount for mounting a label holder on the display hook. Both the locking device and the label holder mount are located at the free end of the merchandise display hook. The locking device and the label holder mount are combined into an integral structure to prevent removal of the items of merchandise from the display hook while accommodating different types of label holders without obscuring visibility of the label or limiting access to the locking device. In preferred embodiments, the invention is an integral locking device and interchangeable label holder mount for use with a merchandise display hook. In a first preferred embodiment shown and described herein, the invention is an integral locking device and interchangeable label holder mount configured for use with a “Geck” style merchandise display hook. In a second preferred embodiment shown and described herein, the invention is an integral locking device and interchangeable label holder mount configured for use with a “3-wire” style merchandise display hook.

In one aspect, the present invention is embodied by a locking device for a merchandise display hook having a free end. The locking device includes a housing disposed adjacent the free end of the merchandise hook and defining an interior cavity adapted for receiving an end portion of the merchandise display hook. The locking device further includes a bayonet at least partially disposed within the interior cavity with the bayonet being movable between an unlocked configuration wherein the end portion of the merchandise display hook is removable from the interior cavity and a locked configuration wherein the end portion of the merchandise display hook is secured within the interior cavity and the locking device is locked onto the merchandise display hook with the bayonet positioned between the end portion and the housing.

In a preferred embodiment, the locking device further includes a shuttle biased by a biasing spring and the bayonet has an interior relief for receiving the shuttle biased by the biasing spring when the bayonet is in the locked configuration. The shuttle may be made of a magnetically attractable material and a magnetic key may be provided for magnetically attracting the shuttle against the biasing spring to thereby permit the bayonet to move from the locked configuration to the unlocked configuration. The bayonet may be movable in a first direction and the shuttle may be biased by the biasing spring in a second direction generally perpendicular to the first direction.

In another preferred embodiment, the locking device further includes a label holder mount provided on the housing for mounting a label holder on the merchandise display hook. The label holder mount is adapted to mount a plurality of different types of label holders on the merchandise display hook. The label holder mount is likewise adapted to mount a faux cover on the merchandise display hook.

In another aspect, the present invention is embodied by a label holder mount for a merchandise display hook having a free end. The label holder mount includes a nose piece disposed adjacent the free end of the merchandise display hook and adapted for mounting a plurality of different types of label holders on the merchandise display hook. The label holder mount further includes a label holder support for supporting at least one of the plurality of different types of label holders.

In a preferred embodiment, the label holder support has at least one attachment rail and the nose piece is configured to engage the attachment rail to attach the label holder support to the label holder mount. The nose piece of the label holder mount may have a dovetail geometry and the at least one attachment rail of the label holder support may be a pair of spaced-apart attachment rails each having a complimentary dovetail geometry. The label holder mount may further include a retainer for retaining the label holder support on the label holder mount and the nose piece may further include at least one side rib having a slot formed therein for receiving the retainer. The retainer may overlie the at least one attachment rail of the of the label holder support to retain the label holder support on the label holder mount. In a first embodiment, the label holder support is a generally planar plate and the at least one attachment rail depends outwardly from the plate in a rearward direction. In a second embodiment, the label holder support is a plate with a laterally-extending support bar depending outwardly from the plate in a forward direction and the at least one attachment rail depends outwardly from the plate in a rearward direction.

In yet another aspect, the present invention is embodied by an integral locking device and interchangeable label holder mount for a merchandise display hook. The locking device includes a housing disposed adjacent a free end of the merchandise hook and defining an interior cavity adapted for receiving an end portion of the merchandise display hook. A shuttle biased by a biasing spring secures the end portion of the merchandise display hook in a locked configuration within the interior cavity of the housing. The label holder mount is integrally formed with the housing of the locking device and disposed adjacent the free end of the merchandise display hook. The label holder mount is adapted for mounting a plurality of different types of label holders on the merchandise display hook.

### BRIEF DESCRIPTION OF THE DRAWINGS

The present invention is better understood with reference to the following detailed description in conjunction with the accompanying drawing figures.

FIG. 1A is a perspective view of a first embodiment of a locking device and label holder mount according to the invention for use with a Geck style merchandise display hook wherein a first type of label holder and a label are shown exploded from the label holder mount.

FIG. 1B is a perspective view of the locking device and label holder mount of FIG. 1A wherein a first embodiment of an interchangeable portion of the label holder mount is shown exploded from the locking device.

FIG. 2A is a perspective view of the first embodiment of a locking device and label holder mount wherein a second type of label holder and a label are shown exploded from the label holder mount.

FIG. 2B is a perspective view of the locking device and label holder mount of FIG. 2A wherein a second embodiment of an interchangeable portion of the label holder mount is shown exploded from the locking device.

FIG. 3A is a front view of the locking device and label holder mount of FIG. 1A.

FIG. 3B is a side view of the locking device and label holder mount of FIG. 1A.

FIG. 3C is a section view of the locking device and label holder mount of FIG. 1A taken in the direction indicated by 3C-3C in FIG. 3A.

FIG. 4A is a front view of the locking device and label holder mount of FIG. 2A.

FIG. 4B is a side view of the locking device and label holder mount of FIG. 2A.

FIG. 4C is a section view of the locking device and label holder mount of FIG. 2A taken in the direction indicated by 4C-4C in FIG. 4A.

FIG. 5A is a perspective view of the first preferred embodiment of a locking device and label holder mount wherein a third embodiment of an interchangeable portion of the label holder mount is shown exploded from the locking device.

FIG. 5B is a front view of the locking device and label holder mount of FIG. 5A.

FIG. 5C is a side view of the locking device and label holder mount of FIG. 5A.

FIG. 6 is a perspective view of the first preferred embodiment of a locking device and label holder mount with a magnetic key for unlocking the locking device wherein the cover of the locking device is shown removed for purposes of clarity.

FIG. 7A is a front view of the locking device and label holder mount of FIG. 6 with the cover removed wherein the locking device is shown in an unlocked configuration.

FIG. 7B is a front view of the locking device and label holder mount of FIG. 6 with the cover removed wherein the locking device is shown in a locked configuration.

FIG. 8A is a section view of the locking device and label holder mount of FIG. 6 taken in the direction indicated by 8A-8A in FIG. 7A wherein the locking device is shown in the unlocked configuration.

FIG. 8B is a section view of the locking device and label holder mount of FIG. 6 taken in the direction indicated by 8B-8B in FIG. 7B wherein the locking device is shown in the locked configuration.

FIG. 9 is a perspective view of a second embodiment of a locking device and label holder mount according to the invention for use with a “3-wire” style merchandise display hook wherein the second interchangeable portion of the label holder mount and the second type of label holder are shown mounted on the label holder mount.

FIG. 10A is a lengthwise section view of the second embodiment of a locking device and label holder wherein the locking device is shown in an unlocked configuration.

FIG. 10B is a lengthwise section view of the second embodiment of a locking device and label holder mount wherein the locking device is shown in a locked configuration.

### DETAILED DESCRIPTION OF THE INVENTION

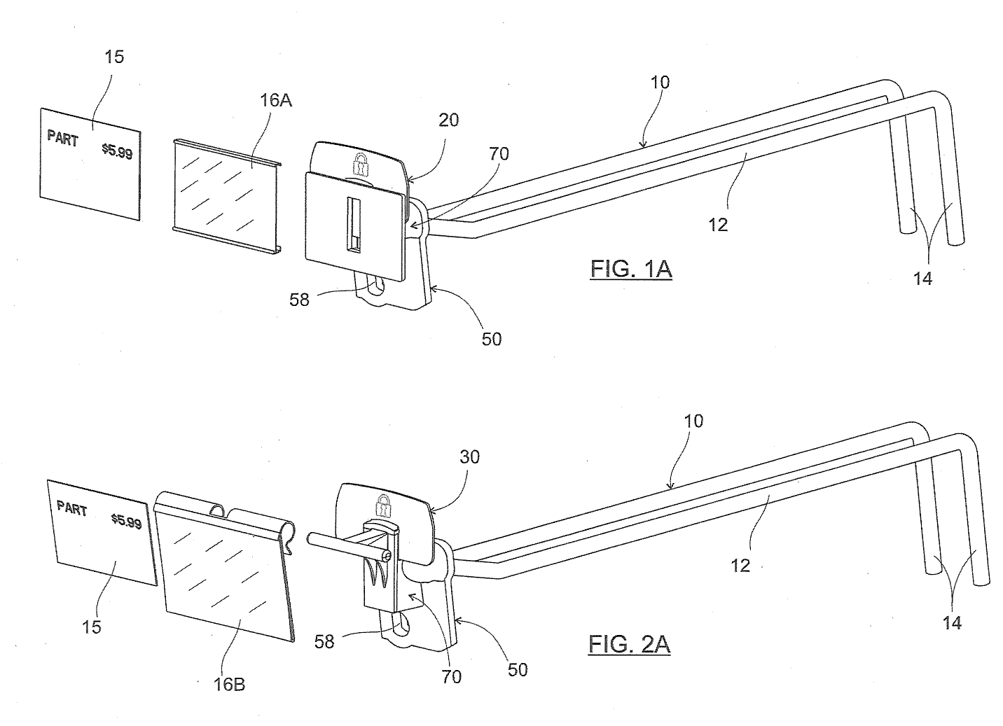

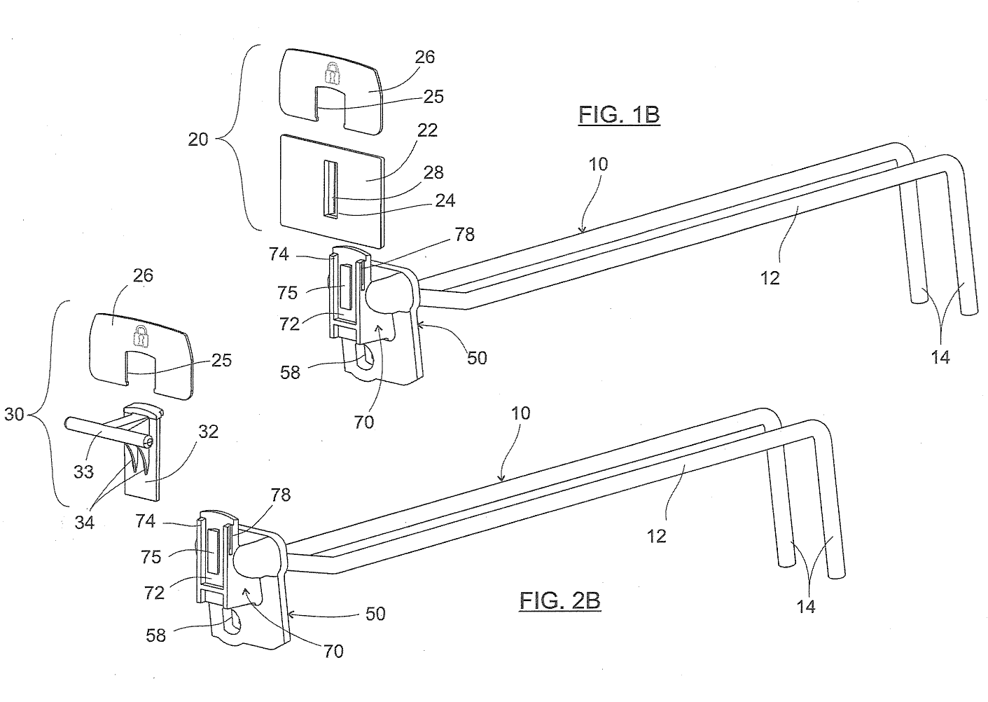

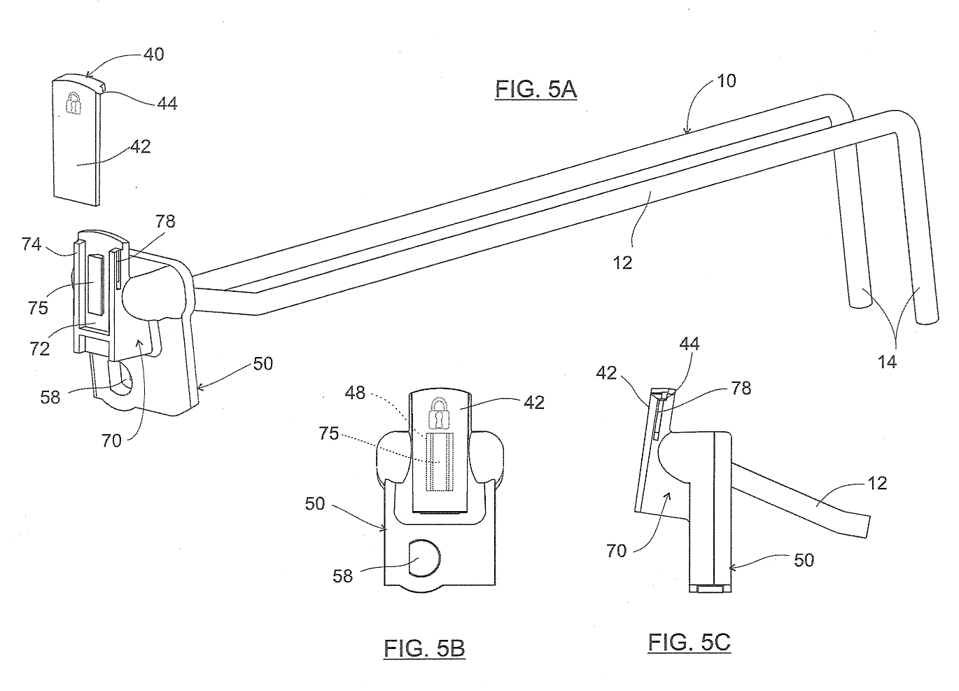

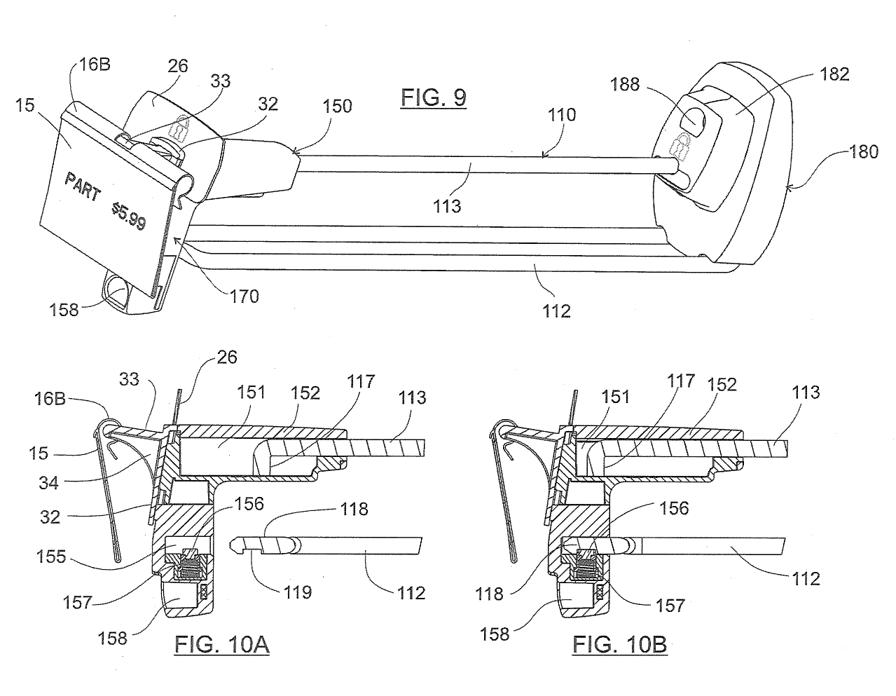

Referring now to the accompanying drawing figures wherein identical reference numerals denote like elements throughout the various views, a first embodiment of a locking device 50 and a label holder mount 70 according to the invention for use with a first style of a merchandise display hook 10 is shown in FIG. 1A, FIG. 2A and FIG. 5A. The first style of merchandise display hook 10 is commonly referred to as a “Geck” style merchandise display hook and is predominately utilized in Europe. In addition, a second embodiment of a locking device 150 and a label holder mount 170 according to the invention for use with a second style of a merchandise display hook 110 is shown in FIG. 9. The second style of merchandise display hook 110 is commonly referred to a “3-wire” merchandise display hook and is utilized in both the United States and Europe.

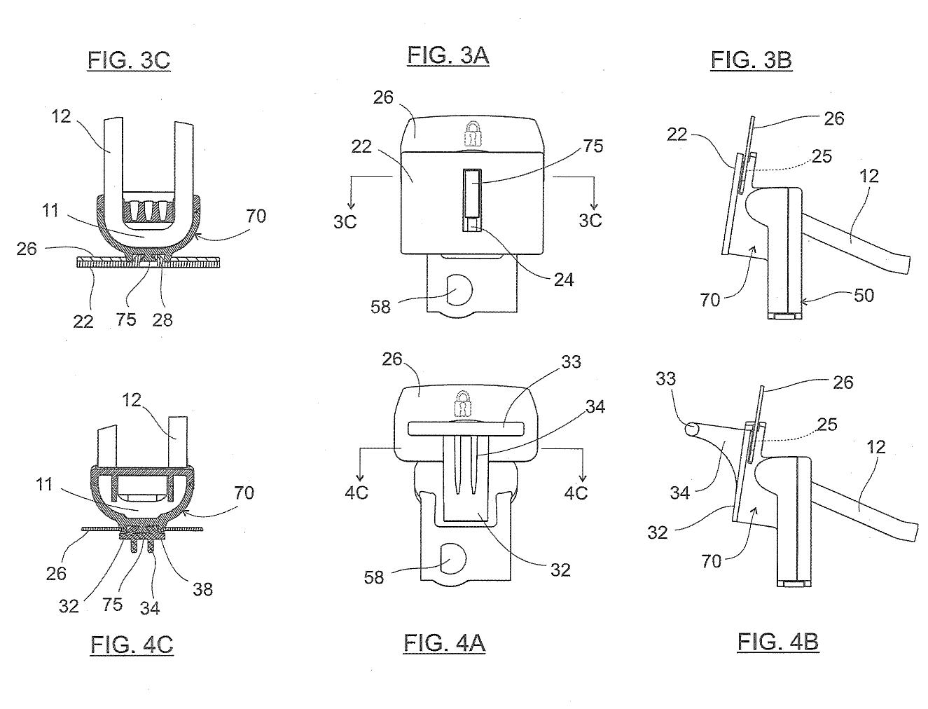

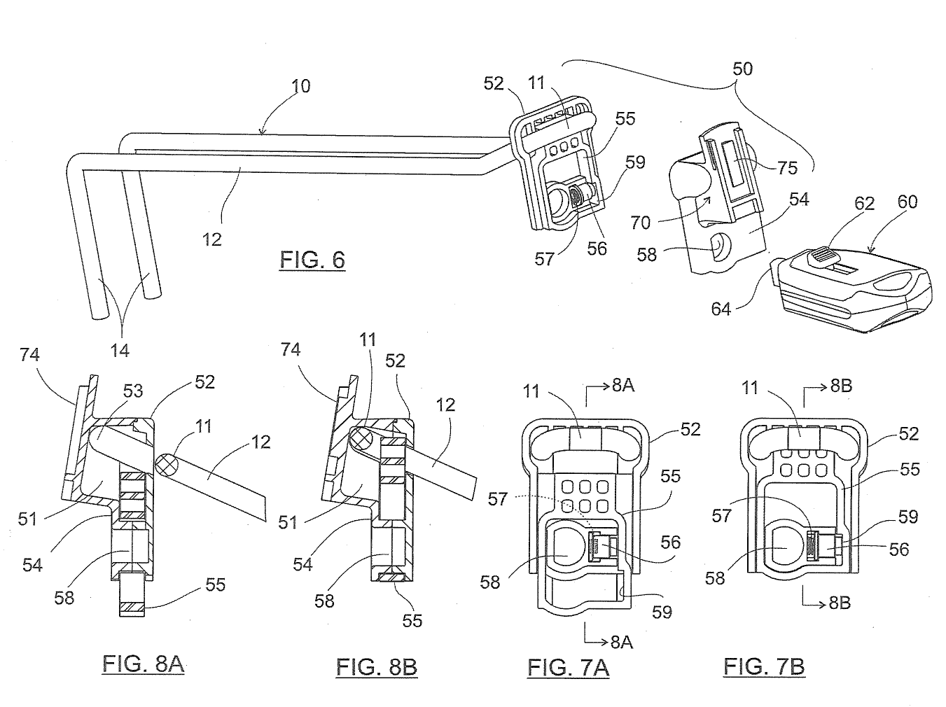

The Geck style merchandise display hook 10 comprises a U-shaped wire 12 having a pair of vertically disposed, downwardly depending mounting prongs 14 at one end for mounting the merchandise display hook on a display support (not shown). For example, the display support may be a vertical wall having a plurality of horizontally and vertically spaced apertures formed therethrough commonly referred to in the United States as “pegboard” and in Europe as “Tego board.” The U-shaped wire 12 comprises a horizontally disposed end portion 11 (e.g. FIG. 3C; FIG. 4C; FIG. 6) at a free end opposite the mounting prongs 14. The end portion 11 is referred to as the free end of the display hook 10 since items of merchandise are placed onto the wire 12 and retrieved from the wire 12 at the end portion 11 when the locking device 50 is unlocked and removed from the display hook. As such, merchandise display hook 10 is operable for supporting and displaying one or more items of merchandise (not shown for purposes of clarity), such as relatively small, relatively expensive consumer products, for example compact discs (CDs), digital video discs (DVDs), battery packs, etc., on the display support. Typically, multiple merchandise display hooks of the same or different types are mounted on the display support for supporting and displaying multiple items of the same or different items of merchandise. In this manner, retailers are able display a large number of products in a limited amount of space and reduce the need to repeatedly stock the items.

As will be shown and described, the label holder mount 70 is adapted to mount a plurality of different types of label holders on the merchandise display hook 10. The label holder mount 170 is likewise adapted to mount a plurality of different types of label holders on the merchandise display hook 110 in the same manner. Accordingly, only the label holder mount 70 will be described in detail herein and it should be understood that the label holder mount 170 is identical to the label holder mount 70 in all relevant respects. A first embodiment of an interchangeable portion 20 of the label holder mount 70 is shown in FIGS. 1A, 1B, 3A, 3B and 3C. A second embodiment of an interchangeable portion 30 of the label holder mount 70 is shown in FIGS. 2A, 2B, 4A, 4B and 4C. A third embodiment of an interchangeable portion 40 of the label holder mount 70 is shown in FIGS. 5A, 5B and 5C. By way of example only, the label holder mount 170 of merchandise display hook 110 is shown in FIGS. 9, 10A and 10B with the interchangeable portion 30 of the label holder mount. It should be understood, however, that the label holder mount 170 may comprise the interchangeable portion 20 or the interchangeable portion 40, as desired. In other words, it is intended that both the label holder mount 70 and the label holder mount 170 be adapted to receive any of the interchangeable portion 20, the interchangeable portion 30 and the interchangeable portion 40, as well as any other type of label holder configured to mate with the nose piece 75 of the label holder mount 70 in the manner described hereinafter. As illustrated in FIG. 1A, the interchangeable portion 20 of the label holder mount 70 is configured to support a known type of label holder 16A that receives a label 15 having indicia printed thereon, for example the name and price of the items of merchandise. As illustrated in FIG. 2A, the interchangeable portion 30 of the label holder mount 70 is configured to support a different known type of label holder 16B that is likewise adapted to receive a label 15. As illustrated in FIG. 5A, 5B and 5C, the interchangeable portion 40 of the label holder mount 70 does not support a label holder, but instead, comprises a generally planar faux cover 42 that provides an aesthetic appearance to the face 72 of the label holder mount. If desired, the faux cover 42 may have printed indicia, for example the security lock symbol shown herein.

As best shown in FIG. 1B and FIG. 2B, the label holder mount 70 comprises a face 72, a pair of laterally spaced-apart side ribs 74, and a nose piece 75 that depends outwardly from face 72 in a forward direction. The side ribs 74 are spaced from the nose piece 75 sufficiently so as to form a relief area on the face 72 fore receiving attachment rails 28, 38, 48 on interchangeable portions 20, 30, 40, respectively, as will be described. Furthermore, at least one, and preferably both, of the side ribs 74 of the label holder mount 70 is provided with a retaining slot 78 that extends downwardly in a generally vertical direction. The nose piece 75 is adapted to receive a label holder support 22, 32 or a faux cover 42, of the interchangeable portions 20, 30, 40, as will be described. The retaining slot(s) 78 of the side ribs 74 are adapted to receive a retainer 26, as will be described. As previously noted, the label holder mount 170 is identical in all relevant respects to the label holder mount 70, including function, except that the geometry of the structure of the label holder mounts 70, 170 may be different as required by the respective locking device 50, 150.

As shown in FIGS. 1B, 3A, 3B and 3C, the interchangeable portion 20 of the label holder mount 70 comprises a label holder support 22 having a centrally located, elongate opening 24. Opening 24 is not necessary for the operation of interchangeable portion 20, but may be required in order to mold the attachment rails 28 on the rear surface of the label holder support 22. Regardless, it should be noted that a portion of attachment rails 28 and nose piece 75 of the label holder mount 70 will be visible through the opening 24, as best illustrated in FIG. 3A and FIG. 3C. Label holder support 22 is configured to be attached to the face 72 of label holder mount 70 with the opening 24 disposed adjacent the nose piece 75. In particular, label holder support 22 has at least one attachment rail 28 (FIG. 1B; FIG. 3C) and nose piece 75 of label holder mount 70 is configured to engage the attachment rail(s) 28 to attach the label holder support 22 to the label holder mount 70. As shown herein, label holder support 22 is in the form of a relatively thin, generally planar plate for supporting the label holder 16A (FIG. 1A) with at least one attachment rail 28 depending outwardly from the plate in a rearward direction for attaching the label holder support to the label holder mount 70. Preferably, the nose piece 75 of the label holder mount 70 has a dovetail geometry and the at least one attachment rail comprises a pair of spaced-apart attachment rails 28 each having a complimentary dovetail geometry.

The interchangeable portion 20 optionally may further comprise a retainer 26 for retaining the label holder support 22 on the label holder mount 70. As shown herein, the retainer 26 is in the form of a relatively thin, generally planar plate defining at least one interior edge 25 configured for engaging the nose piece 75 of the label holder mount 70. In particular, the edge(s) 25 of the retainer engage the retaining slot(s) 78 formed in the side ribs 74 of the nose piece 75. As a result, the retainer 26 overlies the attachment rail(s) 28 and thereby retains the label holder support 22 on the label holder mount 70. If desired, the interior edge(s) 25 of the retainer 26 may have at least one tab, protrusion, detent, or the like, for providing a snap-fit type engagement with the retaining slot(s) 78. Furthermore, the optional retainer 26 may be made of a translucent or transparent material and, if desired, the forward facing surface of the retainer may have printed indicia, for example the security lock symbol shown herein.

As shown in FIGS. 2B, 4A, 4B and 4C, the interchangeable portion 30 of the label holder mount 70 comprises a label holder support 32 having a laterally-extending support bar 33. As shown, the support bar 33 is connected to the label holder support 32 by at least one, and preferably a pair of support ribs 34 that depend outwardly from the label holder support in a forward direction. Label holder support 32 is configured to be attached to the face 72 of label holder mount 70 with support ribs 34 disposed adjacent the nose piece 75. In particular, label holder support 32 has at least one attachment rail 38 (FIG. 4C) and nose piece 75 of label holder mount 70 is configured to engage the attachment rail 38 to attach the label holder support 32 to the label holder mount 70. As shown herein, label holder support 32 is in the form of a relatively thin, generally planar plate having at least one support rib 34 attached to laterally-extending support bar 33 for supporting the label holder 16B (FIG. 1B) with at least one attachment rail 38 depending outwardly from the plate in a rearward direction for attaching the label holder support to the label holder mount 70. Preferably, the nose piece 75 of the label holder mount 70 has a dovetail geometry and the at least one attachment rail comprises a pair of spaced-apart attachment rails 38 each having a complimentary dovetail geometry. The interchangeable portion 30 optionally may further comprise the retainer 26 for retaining the label holder support 32 on the label holder mount 70, in the manner previously described.

As shown in FIGS. 5A, 5B and 5C, the interchangeable portion 40 of the label holder mount 70 comprises a faux cover 42 having a laterally-extending lip 44. As shown, the lip 44 is affixed to the faux cover 42 at an upper end and depends outwardly from the faux cover in a lateral direction sufficiently to overlie the retaining slot(s) 78 on the side rib(s) 74 of the label holder mount 70. Faux cover 42 is configured to be attached to the face 72 of label holder mount 70. In particular, faux cover 42 has at least one attachment rail 48, indicated by hidden (i.e. broken) lines in FIG. 5B, and nose piece 75 of label holder mount 70 is configured to engage the attachment rail 48 to attach the faux cover 42 to the label holder mount 70. As shown herein, faux cover 42 is in the form of a relatively thin, generally planar plate with at least one attachment rail 48 depending outwardly from the plate in a rearward direction for attaching the faux cover to the label holder mount 70 and with laterally-extending rib 44 configured to overlie the attachment rail(s) 48 and the retaining slot(s) 78 of the side rib(s) 74 of the label holder mount in the manner previously described with respect to retainer 26. Preferably, the nose piece 75 of the label holder mount 70 has a dovetail geometry and the at least one attachment rail comprises a pair of spaced-apart attachment rails 48 each having a complimentary dovetail geometry. Although not shown, the interchangeable portion 40 optionally may further comprise the retainer 26 for retaining the faux cover 42 on the label holder mount 70 in the manner previously described with the laterally-extending rib 44 removed.

The first embodiment of a locking device 50 according to the invention is shown in FIGS. 6, 7A, 7B, 8A and 8B. The locking device 50 comprises a housing formed by a base 52 and a cover 54 affixed to the base, typically by fusion or a sonic welding process following assembly of the internal components. Once assembled, the base 52 and the cover 54 of the locking device 50 define an internal cavity 51 for housing movable locking bayonet 55. The bayonet 55 is movable within the internal cavity 51 between an unlocked configuration, shown in FIG. 7A and FIG. 8A, and a locked configuration, shown in FIG. 7B and FIG. 8B. The unlocked configuration permits items of merchandise to be loaded onto (i.e. stocked) and removed from the wire 12 of the merchandise display hook 10, while the locked configuration prevents the items of merchandise from being removed from the merchandise display hook. The cover 54 has a pocket 53 formed therein for receiving the end portion 11 of the U-shaped wire 12 of the merchandise display hook 10 in the unlocked configuration. In the locked configuration, the bayonet 55 secures the locking device 50 on the wire 12 with the end portion 11 positioned within the pocket 53 formed in the cover 54. More particularly, in the locked configuration the bayonet 55 is disposed between the end portion 11 of the wire 12 and the base 52 of the locking device 50 (FIG. 8B).

The locking device 50 further comprises a locking shuttle 56 and a biasing spring 57 for biasing the shuttle 56 against the interior of the bayonet 55. As best shown in FIG. 7A and FIG. 7B, the biasing spring 57 biases the shuttle 56 outwardly from a recess 58 formed in the base 52 and the cover 54 of the locking device 50. The recess 58 is sized and shaped for receiving a magnetic key 60 to permit the bayonet 55 to move from the locked configuration (FIG. 7B) to the unlocked configuration (FIG. 7A). In particular, the magnetic key 60 comprises an actuator button 62 for extending a magnetic actuator 64 that is normally biased in a retracted position. The actuator 64 is extended, for example by sliding the button 62 in the direction shown in FIG. 6, into the recess 58 of the locking device 50. The shuttle 56 is made of a magnetically attractable material, and consequently, is attracted against the biasing force exerted by the spring 57 in the direction of the recess 58. As a result, the shuttle 56 is moved out of a relief 59 formed in the interior of the bayonet 55. With the shuttle 56 displaced from within the relief 59, the bayonet 55 is movable in a downward direction from the locked configuration to the unlocked configuration. As previously mentioned, with the bayonet 55 in the unlocked configuration, the end portion 11 of the wire 12 can be removed from within the pocket 53 (FIG. 8A) of the cover 54 to unlock the locking device 50 from the wire 12. As will be readily appreciated, without the magnetic key 60 disposed in the recess 58, the continuous biasing force exerted by spring 57 will bias shuttle 56 back into the relief 59 as the bayonet 55 is moved from the unlocked configuration to the locked configuration (FIG. 7B).

The second embodiment of a locking device 150 according to the invention is shown in FIGS. 9, 10A and 10B. The locking device 150 is configured for use with a 3-wire style of a merchandise display hook 110. The display hook 110 comprises a U-shaped wire 112 having an end portion (not shown), as previously described. The display hook 110 further comprises an upper wire 113 disposed above the wire 112 in a known manner. The upper wire 113 includes a downwardly-depending end portion 117 at the free end and the wire 112 includes an outwardly-extending nose portion 118 at the free end with a notch 119, for a purpose to be described. An optional locking base 180 may be provided at the opposite end for locking the merchandise display hook 110 onto a vertical wall display support, such as a pegboard (or Tego board), slatwall or wire grid. In the embodiment shown, the locking base 180 comprises a locking device 182 having a recess 188 for receiving the magnetic actuator 62 of the magnetic key 60 to unlock and allow the base 180 to slide outwardly on the upper wire 113 of the display hook 110. The label holder mount 170 is essentially identical to the label holder mount 70 previously described with the exception that the structural geometry of label holder mount 170 is configured to mate with the locking device 150. As shown, the interchangeable portion 30, including label holder support 32 and retainer 26, is attached to the label holder mount 170 such that label holder 16B and label 15 are mounted on the label holder mount in the manner previously described.

The locking device 150 comprises a housing 152, typically formed in two halves affixed together by fusion or a sonic welding process following assembly of the internal components. Once assembled, the housing 152 defines an internal cavity 151 for housing the upper wire 113 and a pocket 155 for receiving the nose portion 118 of the wire 112, as will be described. The locking device 150 is assembled on the display hook 110 with the upper wire 113 trapped within the internal cavity 151 of the housing 152 by the end portion 117. The locking device 150, and more precisely, the housing 152 is movable between an unlocked configuration, as shown in FIG. 10A, and a locked configuration, as shown in FIG. 10B. The unlocked configuration permits items of merchandise to be loaded onto (i.e. stocked) and removed from the wire 112 of the merchandise display hook 110, while the locked configuration prevents the items of merchandise from being removed from the merchandise display hook. The locking device 150 further comprises a locking shuttle 156 and a biasing spring 157 for biasing the shuttle 156 into the pocket 155. As best shown in FIG. 10A, the biasing spring 157 biases the shuttle 156 upwardly from a recess 158 formed in the housing 152 of the locking device 150. The recess 158 is sized and shaped for receiving the actuator 62 of the magnetic key 60 to overcome the biasing force exerted by the spring 157 on the shuttle 156, and consequently, attract the magnetically attractable shuttle 156 in the direction of the recess 158. As a result, the housing 152 can be moved from the locked configuration wherein the shuttle 156 is in engagement with the notch 119 formed in the nose portion 118 of the wire 112 (FIG. 10B) to the unlocked configuration wherein the shuttle 156 is out of engagement with the notch 119 (FIG. 10A).

If desired, the forward (i.e. leading) edge of the nose portion 118 may be provided with a chamfer or similar relief in a known manner for urging the shuttle 156 to move downwardly against the basing force of the spring 157 as the housing 152 of the locking device 150 moves from the unlocked configuration to the locked configuration. As previously described, with the shuttle 156 attracted against the biasing force of the spring 157 by the magnetic key 60, the nose portion 118 of the wire 112 can be removed from within the pocket 155 (FIG. 10A) to unlock the locking device 150 from the wire 112. As will be readily appreciated, without the magnetic key 60 disposed in the recess 158, the continuous biasing force exerted by spring 157 will bias shuttle 156 into the pocket 155 with the housing 152 in both the unlocked configuration and the locked configuration. However, in the locked configuration, the shuttle 156 secures the locking device 150 on the wire 112 with the nose portion 118 positioned within the pocket 155 formed in the housing 152. More particularly, in the locked configuration the shuttle 156 is biased into the notch 119 formed in the nose portion 118 of the wire 112, while in the unlocked configuration, the upper wire 113 is trapped within the cavity 151 defined by the housing 152 of the locking device 50.

The foregoing has described one or more preferred embodiments of a locking device and a label holder mount for a merchandise display hook. While preferred embodiments of the present invention are shown and described herein, it will be readily apparent to those skilled in the art that various modifications can be made thereto without departing from the spirit and scope of the invention. The foregoing description of preferred embodiments of the invention and the best mode for practicing the invention are provided for the purpose of illustration only, and not for the purpose of limitation. In particular, it is envisioned that equivalent embodiments of the invention are well within the skill of an ordinary artisan without departing from the spirit and scope of the appended claims.

That which is claimed is:

1. A locking device for a merchandise display hook having a free end, the locking device comprising:
a housing disposed adjacent the free end of the merchandise hook and defining an interior cavity adapted for receiving an end portion of the merchandise display hook;
a bayonet at least partially disposed within the interior cavity, the bayonet being movable between an unlocked configuration wherein the end portion of the merchandise display hook is removable from the interior cavity and a locked configuration wherein the end portion of the merchandise display hook is secured within the interior cavity and the locking device is locked onto the merchandise display hook with the bayonet positioned between the end portion and the housing.

2. A locking device according to claim 1, further comprising a shuttle biased by a biasing spring and wherein the bayonet has an interior relief for receiving the shuttle bias ed by the biasing spring when the bayonet is in the locked configuration.

3. A locking device according to claim 2, wherein the shuttle is made of a magnetically attractable material and wherein a magnetic key is provided for magnetically attracting the shuttle against the biasing spring to permit the bayonet to move from the locked configuration to the unlocked configuration.

4. A locking device according to claim 3, wherein the bayonet is movable in a first direction and the shuttle is biased by the biasing spring in a second direction generally perpendicular to the first direction.

5. A locking device according to claim 1, further comprising a label holder mount provided on the housing for mounting a label holder on the merchandise display hook.

6. A locking device according to claim 5, wherein the label holder mount is adapted to mount a plurality of different types of label holders on the merchandise display hook.

7. A locking device according to claim 5, wherein the label holder mount is adapted to mount a faux cover on the merchandise display hook.

8. A label holder mount for a merchandise display hook having a free end, the label holder mount comprising:
a nose piece disposed adjacent the free end of the merchandise display hook and adapted for mounting a plurality of different types of label holders on the merchandise display hook.

9. A label holder according to claim 8, further comprising a label holder support for supporting one of the plurality of different types of label holders, the label holder support having at least one attachment rail, and wherein the nose piece of the label holder mount is configured to engage the at least one attachment rail to attach the label holder support to the label holder mount.

10. A label holder according to claim 9, wherein the nose piece of the label holder mount has a dovetail geometry, and wherein the at least one attachment rail comprises a pair of spaced-apart attachment rails each having a complimentary dovetail geometry.

11. A label holder mount according to claim 9, further comprising a retainer for retaining the label holder support on the label holder mount, and wherein the label holder mount further comprises at least one side rib having a slot formed therein for receiving the retainer.

12. A label holder mount according to claim 11, wherein the retainer overlies the at least one attachment rail of the label holder support to thereby retain the label holder support on the label holder mount.

13. A label holder mount according to claim 9, wherein the label holder support comprises a generally planar plate, and wherein the at least one attachment rail depends outwardly from the plate in a rearward direction.

14. A label holder mount according to claim 9, wherein the label holder support comprises a plate and a laterally-extending support bar depending outwardly from the plate in a forward direction, and wherein the at least one attachment rail depends outwardly from the plate in a rearward direction.

15. An integral locking device and interchangeable label holder mount for a merchandise display hook comprising:
a locking device comprising a housing disposed adjacent a free end of the merchandise display hook and defining an interior cavity adapted for receiving an end portion of the merchandise display hook;
a shuttle biased by a biasing spring to secure the end portion of the merchandise display hook in a locked configuration within the interior cavity of the housing; and
a label holder mount integrally formed with the housing of the locking device and disposed adjacent the free end of the merchandise display hook, the label holder mount adapted for mounting a plurality of different types of label holders on the merchandise display hook.
